(19) United States
(12) Patent Application Publication
(10) Pub. No.: US 2011/0250031 A1
(43) Pub. Date: Oct. 13, 2011

(54) Track Bar

(76) Inventor: Randy Ewasko, Cochrane (CA)

(21) Appl. No.: 13/077,701

(22) Filed: Mar. 31, 2011

Related U.S. Application Data
(60) Provisional application No. 61/322,889, filed on Apr. 11, 2010.

(51) Int. Cl. B60P 7/08

(52) U.S. Cl. 410/2; 410/96

(57) ABSTRACT

A structural tie down bar for securing the rear track of a snowmobile to a trailer or other similar structure. The device comprises an elongated beam with a plurality of eyelet projections extending therefrom. The eyelets serve as trailer tie down attachment points for external trailer tie down straps. In a preferred embodiment, the base surface of the beam rests flush against the outer surface of the snowmobile track while the eyelet projections protrude through drive hole penetrations along the track. High tension tie down straps attach to the device using an S-hook or similar attachment means to engage the eyelet projections. Tension loads in the straps act to secure the entire rear end of the snowmobile without compressing the suspension, limiting movement during transportation and reducing potential damage to frame, fairings and other accessories.

### CROSS REFERENCE TO RELATED APPLICATION

This application claims the benefit of U.S. Provisional Application No. 61/322,889 filed on Apr. 11, 2010, entitled “Track Bar”

### BACKGROUND OF THE INVENTION

### FIELD OF THE INVENTION

The present invention relates to tie down support bars for securing snowmobile tracks to a trailer and evenly spreading tension load from a trailer tie down straps to a section of the snowmobile track.

### DESCRIPTION OF THE PRIOR ART

Snowmobile tracks are studded belts that propel the vehicle through snowy and icy terrain. An engine drives a sprocket device that rotates the snowmobile track along a series of pulleys. Drive holes along the length of the track allow the sprocket to grasp the track as it is fed around the pulleys to provide a continuous procession of studs that drive into the ground surface and propel the vehicle forward or backward. Commercially available snowmobile tracks employ a drive hole spacing of nine inches in the widthwise direction, with varying pitch along the track lengthwise direction.

When transporting a motorcycle, snowmobile or other cargo, it is common to employ a vehicle with a series of tie down anchor points and a flat support surface. The anchor points allow engagement of tie down straps that extend therefrom to restrain and affix to onboard cargo. The straps are winched down to reduce their length and place the straps in tension. This applies a stabilizing load on the cargo, securing its position. Careful placement of the tie down straps around the circumference of the cargo ensures it will remain stationary during transport, as shifts in moment are distributed to the appropriate straps.

This method of transport is common practice, but can cause several problems if not implemented correctly. Often the tie down straps are looped over the cargo or attached directly to it, introducing a considerable local load and associated stress concentration around the cargo tie down location. This can be especially problematic for cargo with delicate components or accessories, as they can easily be damaged. A lack of structural hard points may make directly attaching the straps to the cargo very difficult.

An associated problem that is particularly relevant to snowmobiles involves winching the tie down straps to the frame of the vehicle. This method compresses the suspension of the snowmobile, increasing the likelihood of damage to expensive suspension components as well as transporting a vehicle with considerable built-up potential energy in the suspension.

A device is required that solves the known drawbacks of securing a snowmobile to a trailer or other structure using tie down straps, one that does not attach directly to the vehicle frame, does not compress the suspension and does not cause damage to the snowmobile in transit. The present invention fulfills these goals by providing a track bar that engages the drive holes of a snow mobile track and distributes tie down loads across the width of the track, supplying stability to the rear of the snowmobile without compressing its suspension or attaching directly to its fairings or frame. The present invention protects the suspension of the snowmobile by keeping it in its neutral position when the device is secured with tie down straps from the rear.

Several patents and patent applications have been published that involve fastening a snowmobile to a trailer. However, nearly all are directed to a bar, a hook, or a clamp that fastens to the front skis of the snowmobile. Very few devices are available for securing the track of the snowmobile to a trailer. Devices known in the art for securing the track of a snowmobile are intended for security purposes, and do not include means for securing the device to a trailer or other large structure. Patents of this type include U.S. Pat. No. 6,112,560 to Mabee and 5,265,449 to Rashleigh. These devices lock the track in place and prevent it from translating around the pulleys, effectively immobilizing the snowmobile to prevent theft. They do not provide any attachment points for a tie down strap that would allow the devices to act as a snowmobile trailer securing means.

Products currently on the market that describe snowmobile track securing means lack the features of the disclosed invention, most notably the use of a structural beam to distribute load across the track, and corresponding eyelet projections to secure tie down straps through the track itself. The disclosed device is intended for securing a snowmobile track to a trailer or other flat surface with tie down locations for associated straps to secure the snowmobile. The device is simple, yet effective, with no moving parts or complicated locking or attachment means.

### SUMMARY OF THE INVENTION

In view of the foregoing disadvantages inherent in the known types of snowmobile track securement means now present in the prior art, the present invention provides a new snowmobile track tie down bar wherein the same can be utilized for providing convenience for the user when securing a snowmobile track to a trailer or larger structure.

It is therefore an object of the present invention to provide an elongated beam with eyelet projections for integrally mating to a snow mobile track and securing the rear end assembly to a trailer or larger structure.

Another object of the present invention is to provide a track tie down bar that secures the track through the drive holes provided thereon, and evenly distributing load across the track.

Another object of the present invention is to provide a track tie down bar that secures a track on either side of its width, providing alternative attachment point locations for trailer tie down straps, and an alternate means for securing the rear end of a snowmobile.

Yet another object of the present invention is to provide a simple and effective way to secure trailer tie down straps to a snowmobile, and one that does not damage the frame, fairings or suspension of the vehicle in the process of winching it down or transporting it over a long distance.

Other objects, features and advantages of the present invention will become apparent from the following detailed description taken in conjunction with the accompanying drawings.

### BRIEF DESCRIPTIONS OF THE DRAWINGS

FIG. 1 shows a rear perspective view of a typical snowmobile track and the preferred embodiment of the track bar in its working position.

FIG. 2 shows a perspective view beneath the snow mobile track with the preferred embodiment of the track bar in its working position.

FIG. 3 shows a front view of the preferred embodiment of the disclosed invention.

FIG. 4 shows a bottom view of the preferred embodiment of the disclosed invention.

FIG. 5 shows a side view of the preferred embodiment of the disclosed invention.

FIG. 6 shows a front view of a second embodiment of the disclosed invention.

FIG. 7 shows a front view of a third embodiment of the disclosed invention.

### DETAILED DESCRIPTION OF THE INVENTION

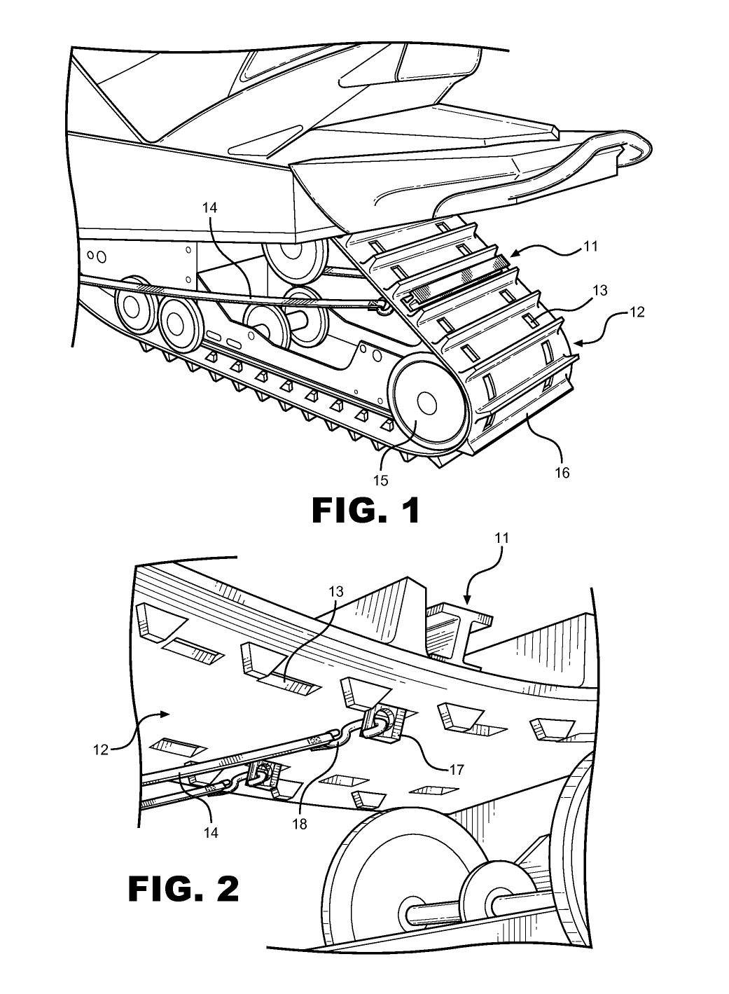

Referring now to FIG. 1, there is shown a rear perspective view of a typical snowmobile track 12. The track 12 is a tension bearing member that is run around a series of pulleys 15 to rotate a plurality of studs 16 that grasp the ground surface and propel the vehicle forward or backward, depending on the direction of travel of the track 12 and associated studs 16. A sprocket type device engages the track to force its movement using a series of drive holes 13 along the track 12 length. The drive holes 13 are penetrations in the track 12 that the teeth of a sprocket can engage and introduce an in-plane load 12 to translate it around the pulleys and move the snowmobile.

While in transit, the track 12 is stationary. The disclosed invention utilizes the stationary track 12 and drive holes 13 to secure the entire snowmobile to a larger structure, such as a trailer or flatbed truck. Again referring to FIG. 1, the preferred embodiment of the track tie down bar 11 is placed along the stationary track 12 between studs 16 and aligned with the drive holes 13. A plurality of tie down straps 14 are utilized to engage the track tie down bar 11 while it is positioned on the track 12 and eyelet projections are placed through the drive holes. Tension load in the straps 14 is transferred to the bar 11, which distributes load across the track 12 and immobilizes the entire rear section of the snowmobile.

Referring now to FIG. 2, there is shown a perspective view beneath the snow mobile track 12 and the preferred embodiment of the track tie down bar 11 in its working position. Eyelet projections 17 protrude through horizontally-spaced drive holes 13 along the track 12. Tie down straps 14 extend from a fixed position and attach to the eyelets 17 using an S-hook device 18 or similar engagement means. The track tie down bar 11 employs two eyelet projections 17 along its length, evenly distributing the load between the two and transferring the tension load in the straps 14 to the bar 11. The bar 11 is mounted flush on the top side of the track 12, and distributes the load along a section of the track 12, securing the rear end of the snowmobile during transport.

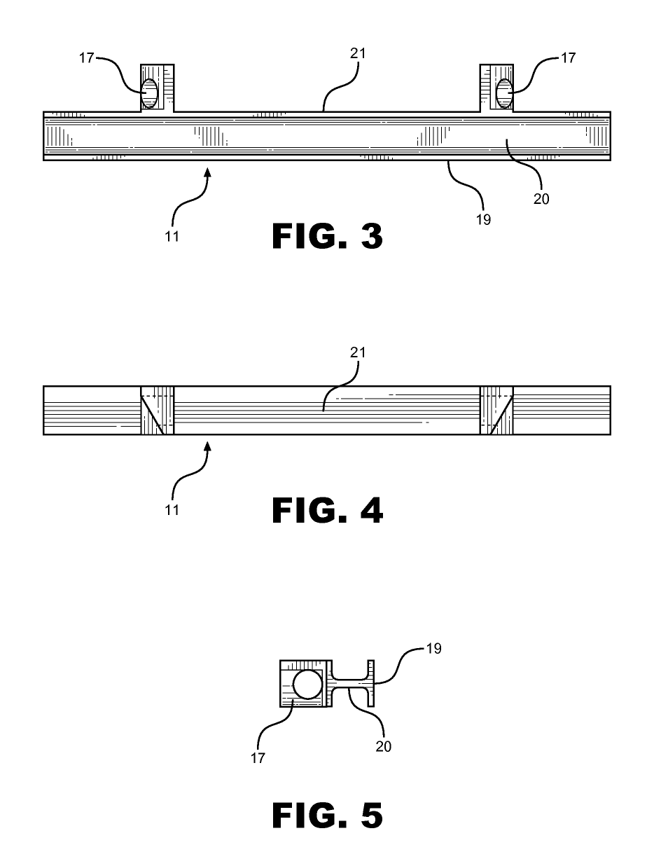

Referring now to FIG. 3, there is shown a front view of the preferred embodiment of the track tie down bar 11. Two eyelet projections 17 extend from the base surface 21 of a beam section 20 to penetrate through the drive holes of a snowmobile track. The base surface 21 lies flat against the outer surface of the track to distribute load across its length. The cross section of the beam 20 may take any structural form required to withstand the tie down strap loads, which create shear load introductions along its length. Proper sizing may be required to determine an appropriate area, moment of inertia, material and shape that satisfy the shear, bending and torsion loads introduced along the beam, as well as manufacturing considerations that may prefer a specific cross section over another prior in production.

Referring now to FIG. 4, there is shown a bottom view of the preferred embodiment of the track tie down bar 11. The base surface 21 is highlighted. This surface is flat to mount flush with the outer surface of the snowmobile track.

Referring now to FIG. 5, there is shown an end view of the preferred embodiment of the track tie down bar. Eyelet projections 17 provide concentric through holes to engage the attachment means of a trailer tie down strap. The thickness and design of the eyelet walls may be any gauge required to withstand the bearing loads introduced by the tie down straps during transportation. Shifts in momentum of the trailer and the snowmobile manifest into shear load introductions along the through holes of the eyelet projections 17. These projections introduce the load into the beam cross section 20, which may be any structural cross section desirable. The cross section shown in the figures is a preferred embodiment, in which an I-section is utilized for adequate structural stiffness and strength. Other embodiments may take the form of a square tube, T-section, J-section, or any other cross section that may be desired by one skilled in the art.

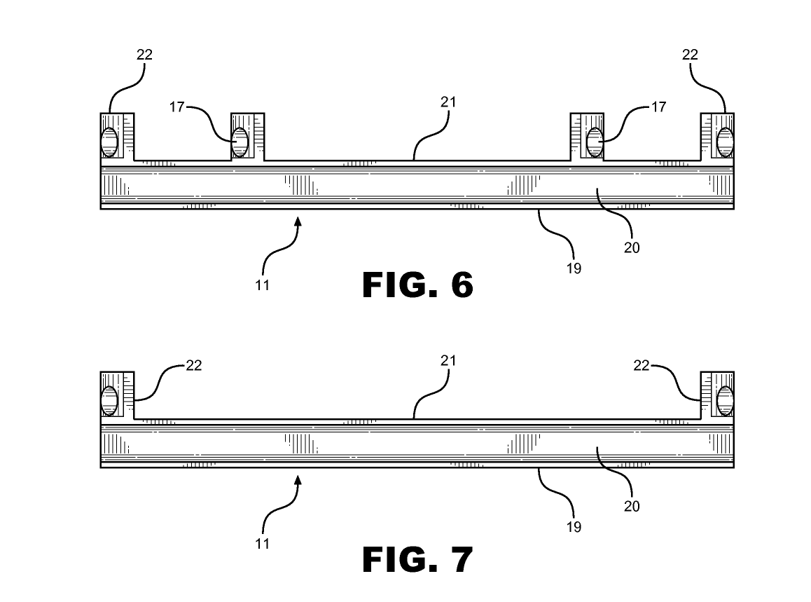

Referring now to FIG. 6, there is shown a front view of the second embodiment of the track tie down bar 11. In this embodiment, additional eyelet projections are provided, including those that run through the drive holes of the track 17, and those that extend laterally beyond the width of the track 22 and provide attachment points for tie down straps on either side of the track. The base surface 21 rests flush against the track, while the beam 20 provides the structural stability to react tie down loads and spread load across the width of the track. This embodiment provides additional flexibility to the user by attaching tie down straps in a plurality of locations, while utilizing the drive hole projections 17 to securely attach to and immobilize a snowmobile track.

Referring now to FIG. 7, there is shown a front view of the third embodiment of the track tie down bar 11. The central eyelet projections are removed in favor of end projections 22 that attach to tie down straps on either side of the snowmobile in the widthwise direction. The base surface 21 rests flush against the track, while the beam 20 provides the structural stability to react tie down loads and spread load across the width of the track. This provides a track bar 11 that is not limited to those that employ inner spaced drive holes. The tension in the tie down straps provides the load for the base surface 21 to bear into the track and immobilize the rear of the snowmobile.

In use an individual places a snowmobile between a series of tie down anchor points on a trailer or other flat surface. In the preferred embodiment of the disclosed invention, the track tie down bar is placed between the studs of the snowmobile tracks and the eyelet projections are placed through corresponding drive holes between studs. One end of a tie down strap is engaged with the projections on the underside of the snowmobile track while a second end is attached to an anchor point. This operation is repeated for the second eyelet projection of the track tie down bar. Both straps are winched tightly to reduce their length and introduce a tension load in the strap. The tension load places a shear load on the eyelet projections, and a combination load on the track tie down bar cross section depending on the strap tensile load vector relative to the beam. With the two straps taughtly engaged, the rear of the snowmobile is fixed in position, prepared for transport. Shifts in momentum in transit are reacted by the straps and the track bar. The second embodiment of the invention incorporates end projections for additional tie down strap locations, while the third embodiment provides only end projections for tie down purposes. The steps for attaching the straps to the track bar are the same for each embodiment. The location of the eyelets may differ according to the elements of the specific embodiment.

With the disclosed device, and the method of securing the rear track of a snowmobile, components on the body of the snowmobile are not loaded or subject to damage. The straps do not engage the frame of the snowmobile, and no length of the straps wraps over a fairing or snowmobile accessory that may be prone to damage if subjected to load during transport. Make-shift attach points and overlapping straps across the body of the snowmobile are unnecessary when employing the present invention. The frame is not directly loaded and the suspension remains at its neutral position. The fairings are also not subjected to any unintended loading. The rear of the snowmobile is effectively immobilized for secure transport over any distance.

The front of the snowmobile, specifically the skis, may be clamped or otherwise supported to prevent their movement using means appropriate to one skilled in the art. These means may take the form of a clamp, a strap or similar immobilizing structure. The rear track bar maintains the position of the rear of the snowmobile, while the front is otherwise supported.

The beam of the track bar acts to spread the load across the rear track, as opposed to locating tie down hooks at discrete locations along track. Discrete tie down locations introduce point loads that can locally deform the snowmobile track, which would necessitate a repair or replacement of the entire track prior to use. The track bar alternatively distributes the tie down loads, preventing local deformation or tearing of the track during transportation or storage. Specific materials for the track bar may be any suitable material for the applied loads and intended uses of the bar. These may include metallic materials such as aluminum, plastics, or composite materials that fulfill the structural requirements of the task while meeting other needs such as weight, producability, cost and availability of material.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A snowmobile track bar tie down device for securing the rear position of a snowmobile, comprising:
an elongated beam with a first and second end and a planar base surface;
a plurality of eyelet projections extending from said base surface and perpendicular to said beam;
said eyelet projections having concentric through holes.

2) A device as in claim 1, wherein said elongated beam has an I-beam cross section.

3) A device as in claim 1, wherein said elongated beam has a square tube cross section.

4) A device as in claim 1, wherein said eyelet projections are interior to said first and second beam end.

5) A device as in claim 4, wherein said interior eyelet projections engage drive holes of a snow mobile track.

6) A device as in claim 1, wherein said plurality of eyelet projections are located interior to said first and second beam end and at said first and second beam end.

7) A device as in claim 6, wherein said interior eyelet projections engage drive holes of a snow mobile track.

8) A device as in claim 1, wherein said plurality of eyelet projections are located at said first and second beam end.

9) A snowmobile track bar tie down device for securing the rear position of a snowmobile, comprising:
an elongated beam with a first and second end and a planar base surface;
a plurality of interior eyelet projections extending from said base surface and perpendicular to said beam;
a snowmobile track with a plurality of drive holes;
said interior eyelet projections penetrate through said drive holes;
concentric through-holes in said eyelet projections affix to tie down strap connections means.

10) A device as in claim 9, wherein said elongated beam has an I-beam cross section.

11) A device as in claim 9, wherein said elongated beam has a square tube cross section.

12) A device as in claim 9, wherein a plurality of end eyelet projections are located at said first and second beam end.

13) A method of securing the rear track of a snowmobile for transport, comprising the steps of:
positioning said snowmobile between a plurality of anchor points;
positioning a track bar tie down device on said rear track between elevated studs;
engaging eyelet projections from said beam and said anchor points with a plurality of tie down straps;
engaging a first end of said tie down straps with a said eyelet projection, a second end of said tie down straps with a said anchor point;
winching down said tie down straps to introduce loads on said track bar tie down device prior to transport or storage.

14) A method as described in claim 13, further comprising the steps of:
placing eyelet projections of said track bar tie down device through drive holes in said rear track.
